(19) United States
(12) Patent Application Publication
(10) Pub. No.: US 2002/0030437 A1
(43) Pub. Date: Mar. 14, 2002

(54) Light-emitting device and backlight for flat display

(76) Inventors: Nobuhiro Shimizu, Nara-shi (JP); Teruaki Shigeta, Neyagawa-shi (JP)

Correspondence Address: HARNESS, DICKEY & PIERCE, PLC, P.O. BOX 828, BLOOMFIELD HILLS, MI, 48303, US

(21) Appl. No.: 09/949,894

(22) Filed: Sep. 12, 2001

(30) Foreign Application Priority Data
Sep. 13, 2000 (JP) 2000-278830

(51) Int. Cl. H01J 1/62

(52) U.S. Cl. 313/495

(57) ABSTRACT

A light-emitting device includes a discharge container having a discharge space inside; and a plurality of electrodes provided in the discharge space, a circumference of each of the plurality of electrodes being covered with a dielectric structure, and an alternating voltage being applied to the plurality of electrodes.

### BACKGROUND OF THE INVENTION

The present invention relates to light-emitting devices and backlights for flat displays. In particular, the present invention relates to light-emitting devices using rare gas discharge and backlights for flat displays.

In recent years, in view of global environment protection, there is a vigorous trend toward regulations or a ban on use of toxic substances. One aspect of this trend is to develop mercury-free fluorescent lamps. Mercury has a very important function to radiate ultraviolet rays in a fluorescent lamp to make phosphors luminous On the other hand, mercury is accumulated in the bodies of the organisms and has the hazard of harming the organisms. At present, the most promising material as an ultraviolet ray radiation material substituted for mercury is a rare gas such as krypton and xenon. Among these, xenon is widely used as a gas that can make a phosphor luminous in high excitation efficiency.

As shown in FIG. 18, xenon is excited by, for example, collision of electrons, and a radiation at 147 nm occurs at the resonance line level (8.45 ev), and a radiation at 172 nm occurs from excimer molecules that are generated from the metastable state level (8.3 ev) via triple collision. In order to increase the radiation efficiency at 147 nm and 172 nm, various discharge forms are studied, and a discharge form using dielectric barrier discharge is reported to have the highest radiation efficiency at present.

The dielectric barrier discharge is discharge that is performed through a dielectric and is characterized in that a large number of microdischarges occur, and each microdischarge ends instantly. In the dielectric barrier discharge, since discharge ends instantly, electrons excited to the resonance line level are not excited again to a higher level band and radiate light at 147 nm or 172 nm.

On the other hand, discharges other than the dielectric barrier discharge, discharge does not end instantly, but continues for a long time, and therefore the electron density is excessive. As a result, the electrons excited to the resonance line level are excited again to a higher level band, as shown in FIG. 18. Thereafter, the electrons radiate near infrared light or visible light. The near infrared light does not contribute to light emission of phosphors and visible light has a very low emission efficiency, so that when these light are radiated, the emission efficiency is reduced.

Conventionally, the light-emitting device using the dielectric barrier discharge can be categorized roughly into 2 types, depending on the arrangement of electrodes. One is a light-emitting device of surface discharge type in which a plurality of electrodes is disposed only on one substrate, and discharge is caused on that surface (e.g., Japanese Laid-open Patent Publication (Tokkai) Nos. 6-231731 and 11-31480). The other is a light-emitting device of opposing discharge type in which at least one electrode is disposed on each of two substrates and discharge is caused between the electrodes on the two opposing substrates (e.g., Japanese Laid-Open Patent Publication (Tokkai) Nos. 8-22805 and 8-287869). The light-emitting device of each type will be described with reference to FIGS. 16 and 17.

FIG. 16 is a schematic cross sectional view of a light-emitting device of surface discharge type The light-emitting device shown in FIG. 16 has a discharge container 3 including a back substrate 11 (a thickness of about 3 mm) made of, for example, soda-lime glass, a front substrate 21 (a thickness of about 3 mm) opposed to the back substrate 11, and a frame 71 positioned between the back substrate 11 and the front substrate 21 (a distance between the back substrate 11 and the front substrate 21 of 1 to 10 mm). A plurality of linear electrodes 4a (an electrode width of 0.2 to 2 mm and a distance between the electrodes of 5 to 15 mm) is formed on the surface of the back substrate 11, and a dielectric layer 130 (thickness of 50 to 500 μm) made of, for example, glass, is formed so as to cover the linear electrodes 4a. A light-emitting layer 52 made of, for example, phosphors is formed on the surface of the dielectric layer 130. On the other hand, on the surface of the front substrate 21, only the light-emitting layer 52 is formed. The discharge container 3 is sealed with the back substrate 11, the front substrate 21 and the frame 71, and a rare gas 101 (e.g., xenon) is enclosed in the discharge container 3 at a pressure of about 1 to 100 kPa.

Next, the operation of the light-emitting device shown in FIG. 16 will be described. First, when a sine wave or pulse voltage of 500 to 3000V is applied to the adjacent linear electrodes 4a, the dielectric layer 130 is polarized, and an electric field is generated between every pair of adjacent linear electrodes 4a. When this electric field exceeds an electric field for discharge start for xenon, microdischarges start. At this time, charges are accumulated on the surface of the dielectric layer 130 by the microdischarges. When the synthesized electric field of the internal electric field caused by the accumulated charges and the external electric field in the opposite direction caused by the polarization of the dielectric layer 130 becomes lower than an electric field for maintaining discharge, the microdischarges end. The duration time of the microdischarges is very short, and immediately after the discharge ends, next microdischarges start in a location where microdischarges have not occurred yet. The repetition of the microdischarges spreads discharge plasma 12a uniformly. The discharge plasma 12a generated by the microdischarges is curved, as shown in FIG. 16. When occurrence of the microdischarges all over stops, the discharge ends completely.

Next, a voltage in the opposite direction is applied to the linear electrodes 4a. When the sum of the electric field caused by the accumulated charges on the surface of the dielectric layer 130 and the electric field occurring in the gap caused by the voltage applied to the electrodes exceeds the discharge start voltage, discharge starts again. In this manner, every time the direction in which a voltage is applied to the electrodes is changed, the start and stop of discharge is repeated. Ultraviolet light (not shown) emitted by the discharge plasma 12a is converted to visible light (not shown) by the light-emitting layers 52 provided on the back substrate 11 and the front substrate 21, and is guided outside the discharge container 3.

FIG. 17 is a schematic cross-sectional view of a light-emitting device of opposing discharge type The light-emitting device shown in FIG. 17 has a discharge container 4 including a back substrate 12 (a thickness of about 3 mm) made of, for example, soda-lime glass, a front substrate 22 (a thickness of about 3 mm) opposed to the back substrate 12, and a frame 72 positioned between the back substrate 12 and the front substrate 22 (a distance between the back substrate 12 and the front substrate 22 of 1 to 10 mm). A plurality of electrodes 4b and 4c (an electrode width of 0.2 to 2 mm and a distance between the electrodes of 5 to 15 mm) are formed on the surface of the back substrate 12 and the front substrate 22, respectively. A dielectric layer 131 (thickness of 50 to 500 μm) is formed on the back substrate 12 and the front substrate 22 so as to cover the electrodes 4b and 4c. on top of these, a light-emitting layer 53 is formed. In this configuration, as the electrodes 4c on the front substrate 22, for example, striped electrodes or transparent electrodes made of, for example, indium tin oxide are used for the purpose of reducing the electrode area not to block visible light from the light-emitting layer 53. Similarly in the surface discharge type shown in FIG. 16, the discharge container 4 is sealed with the back substrate 12, the front substrate 22 and the frame 72, and a rare gas 102 (e.g., xenon) is enclosed in the discharge container 4 at a pressure of about 1 to 100 kPa.

The operation of the light-emitting device shown in FIG. 17 is basically the same as that of the light-emitting device shown in FIG. 16 The operation of the light-emitting device shown in FIG. 17 will be described briefly. When a sine wave or pulse voltage of 500 to 3000V is applied between the opposing electrodes 4b and 4c, a plurality of discharge plasmas 12b occurs in the discharge container 4. At this time, ultraviolet light (not shown) emitted by the discharge plasma 12b is converted to visible light (not shown) by the light-emitting layers 53 provided on the back substrate 12 and the front substrate 22, and is guided outside the discharge container 4.

The light-emitting device of opposing discharge type shown in FIG. 17 has mainly the following three problems.

First, when a thin light-emitting device such as a liquid crystal backlight is desired, the distance between the electrodes cannot be long. In general, it is empirically known that when the discharge gap is short, the emission efficiency is reduced. This seems to be because the emission efficiency in the vicinity of the electrode is low. When a thin light-emitting device is configured with an opposing discharge type, the distance between the electrodes is short, that is, the discharge gap is short, and therefore the emission efficiency is reduced. It seems that one factor why the emission efficiency of a plasma display panel does not increase from several 1 m/w is that the discharge gap is as short as several hundreds of micrometers.

Secondly, the electrodes are formed on a surface from which light emits. In the case where it is desired to let light out from the front of the light-emitting device and the electrodes 4c formed on the front glass substrate 22 are formed of a non-translucent material such as metal, then a part of the light from the light-emitting layer 53 is scattered or absorbed by the electrodes 4c, so that the intensity on the light-emitting surface is reduced. In order to prevent the reduction of the intensity on the light-emitting surface due to scattering and absorption of the electrodes 4c, it might be effective to reduce the electrode area- However, when the electrode area is reduced, the intensity is reduced, and the resistance of the electrodes is increased. Even if the electrodes 4c are formed of a translucent material, the thickness is required to be small in order to increase the transmittance of the electrodes, which leads to an increase of the electrical resistance.

Thirdly, phosphors deteriorate significantly. As understood from FIG. 17, the light-emitting device of opposing discharge type has a structure in which ions in the discharge plasma 12b collide directly with the lightemitting layer 53 (phosphor layer). The collision of the ions with the phosphors deteriorates the phosphors and leads to a significant decrease of the intensity, This deterioration of the phosphors is the largest problem of the opposing discharge type, and various researches also have been conducted for plasma display panels of DC type having a similar structure

Next, the problems of the light-emitting device of surface discharge type shown in FIG. 16 will be described.

First, in the light-emitting device of surface discharge type, unlike opposing discharge type light-emitting devices, the discharge gap can be increased easily. However, when the discharge gap is large, the start voltage is accordingly large, so that the discharge gap should be restricted within the range in which the start voltage is not too high.

Furthermore, in the light-emitting device of surface discharge type, unlike opposing discharge type light-emitting devices, all the electrodes 4a are provided on the back substrate 11, so that there is no decrease in the intensity on the light-emitting surface due to scattering and absorption by the electrodes. In addition, since the electrodes are formed on only one substrate, the damages to the phosphors can be halved. However, the largest problem of the surface discharge type device is that the discharge plasma 12a is easily affected by the surface of the substrate, as disclosed in Japanese Laid-Open Patent Publication (Tokuhyo) No. 2000-500916. This is because the discharge plasma 12a passes near the back substrate 11, as understood from FIG. 16. Hereinafter, the influence of the surface of the substrate on the discharge plasma 12a will be described.

A part of electrons and ions in the discharge plasma travel in the direction to the substrate by diffusion. In general, the speed of electrons is higher than that of ions, so that in a regular state, more electrons reach the surface of the substrate than ions. As a result, the electrons on the surface of the substrate form a negative electric field near the surface, and serve to repel the following electrons. This negative electric field reduces the speed of the electrons and attracts ions on the other hand, and ultimately the negative electric field increases until electron current and ion current that reach the surface are equal. This mechanism is referred to as “ambipolar diffusion” (see “Plasma Foundation Engineering” by Noburiki Tsutsumi published by Uchida Rokakuho). In the surface discharge type, when the distance between the discharge plasma and the substrate is reduced, the loss ratio due to recombination of electrons and ions on the surface of the substrate is increased. In addition, the numbers of resupplied electrons and ions are also increased to maintain the conductivity of the discharge plasma and the densities of the electrons and the ions are increased. As described above, when the electron density is excessive, reexcitation from the resonance line level of xenon becomes active, so that the emission efficiency is reduced (see FIG. 18). Furthermore, the increase of the electron density causes non-uniformity of the intensity of the electric field, which may cause discharge to be unstable.

A problem common to the two types of light-emitting devices of opposing discharge type and surface discharge type is that a large number of high temperature processes are required in the production process of the light-emitting devices. In either case of the two types of light-emitting devices, the total of five high temperature processes, that is, forming electrodes, forming a dielectric layer, forming a light-emitting layer, sealing and evacuation, at a temperature of about 600° C. at the maximum are required In order to withstand these high temperatures, it is necessary to use a glass substrate having a small thermal strain and a large thickness.

### SUMMARY OF THE INVENTION

Therefore, with the foregoing in mind, it is an object of the present invention to provide a light-emitting device having more excellent characteristics than those of the conventional light-emitting devices.

A light-emitting device of the present invention includes a discharge container having a discharge space inside; and a plurality of electrodes provided in the discharge space, a circumference of each of the plurality of electrodes being covered with a dielectric structure, and an alternating voltage being applied to the plurality of electrodes.

It is preferable that the dielectric structure is spaced away from the discharge container except at a portion where the dielectric structure is supported by the discharge container.

In one embodiment, the dielectric structure is a glass tube, and each of the plurality of electrodes is provided inside the glass tube so as not to be exposed to the discharge space, and is extended to the outside of the discharge container.

It is preferable that each of the plurality of electrodes is hollow inside.

Each of the plurality of electrodes may have a mesh structure.

Each of the plurality of electrodes may be split into at least two portions along a longitudinal direction of the dielectric structure.

It is preferable that the discharge container includes a translucent portion in at least one portion, and a light-emitting layer is provided in at least one portion on the inner surface of the discharge container.

In one embodiment, the discharge container includes a front substrate and a back substrate that are opposed to each other, and the plurality of electrodes are disposed equidistantly on a plane that is parallel to the front substrate or the back substrate.

It is preferable that the discharge container is provided with a groove for receiving a part of the dielectric structure to support the dielectric structure is preferable that the plurality of electrodes is disposed such that electrodes connected to a high pressure side of a power source alternate with electrodes connected to a ground side of the power source.

In one embodiment, the light-emitting device includes pairs of dielectric structures, the dielectric structures of each pair being in contact with each other. The electrodes whose circumferences are covered with the pair of dielectric structures that are in contact with each other are in the same electrical potential, and the electrodes that are in the same electrical potential constitute the electrodes connected to the high pressure side of the power source or the electrodes connected to the ground side of the power source.

It is preferable that an area of each electrode positioned at both ends of the plurality of electrodes is a half of an area of each electrode positioned in a portion other than the both ends

In one embodiment, the plurality of electrodes are covered with the dielectric structures such that one dielectric structure covers the circumference of one electrode, and the area of each electrode positioned in a portion other than both ends is substantially equal.

In one embodiment, each of the electrodes positioned at both ends is an electrode whose circumference is covered with one dielectric structure, and the electrodes positioned in a portion other than the both ends are electrodes each of which is covered with one dielectric structure in its circumference, the electrodes being constituted with pairs of two adjacent electrodes, and the dielectric structures covering the two adjacent electrodes are in contact with each other, and the sum of the electrode area of the two electrodes is twice the area of each of the electrodes positioned at the both ends.

It is preferable that at least one portion on the surface of each electrode of the plurality of electrodes is attached tightly to the dielectric structure.

A backlight for a flat display of the present invention includes a discharge container having a discharge space inside, in which at least a rare gas is enclosed as a luminous material in the discharge space; a plurality of tubes made of dielectric and provided in the discharge space while being spaced away from the discharge container except at a portion at which the tubes are supported by the discharge container; and electrodes each of which is provided in each of the plurality of tubes and to which an alternating voltage is applied. The discharge container includes a front substrate and a back substrate that are opposed to each other, and the plurality of tubes are disposed on a plane that is parallel to the front substrate or the back substrate. The discharge container includes a translucent portion in at least one portion. A lightemitting layer is provided in at least one portion on the inner surface of the discharge container.

The light-emitting device of the present invention includes a plurality of electrodes provided in the discharge space, each of which is covered with a dielectric structure in its circumference, and therefore has the characteristics more excellent than those of the conventional devices.

This and other advantages of the present invention will become apparent to those skilled in the art upon reading and understanding the following detailed description with reference to the accompanying figures.

### BRIEF DESCRIPTION OF THE DRAWINGS

FIG. 1A is a vertical cross-sectional view of a light-emitting device of Embodiment 1 according to the present invention.

FIG. 1B is a horizontal cross-sectional view of a light-emitting device of Embodiment 1 according to the present invention.

FIG. 2 is a perspective view showing an appearance of an frame 70 of Embodiment 1.

FIG. 3 is a cross-sectional view showing a variation of the electrodes 40 of Embodiment 1.

FIG. 4A is a schematic view showing a discharge pillar 120 generated between the electrodes 40 when an alternating voltage is applied thereto.

FIG. 4B is a schematic view showing a discharge pillar 120 generated between the electrodes 40 when direct current (DC) is applied thereto.

FIG. 5 is a horizontal cross-sectional view of a variation of the light-emitting device of Embodiment 1.

FIG. 6 is a horizontal cross-sectional view of another variation of the light-emitting device of Embodiment 1.

FIG. 7 is a cross-sectional view of electrodes 41 of Embodiment 2.

FIG. 8 is a cross-sectional view showing the configuration of dielectric structures 32 and electrodes 42 of Embodiment 3.

FIG. 9 is a cross-sectional view showing the configuration of dielectric structures 33 and electrodes 43 of Embodiment 7.

FIG. 10 is a view showing the configuration of dielectric structures 34 and electrodes 44 of Embodiment 8.

FIG. 11 is a view showing the configuration of dielectric structures 35 and electrodes 45 of Embodiment 8.

FIG. 12 is a view showing the configuration of dielectric structures 36 and electrodes 46 of Embodiment 8.

FIG. 13 is a view showing the structure of dielectric structures 37 and electrodes 47 of Embodiment 8.

FIG. 14 is a view showing the configuration of dielectric structures 38 and electrodes 48 of Embodiment 8.

FIG. 15 is a perspective view showing the configuration of a light-emitting device of Embodiment 9.

FIG. 16 is a view showing a cross-sectional configuration of a conventional light-emitting device of surface discharge type.

FIG. 17 is a view showing a cross-sectional configuration of a conventional light-emitting device of opposing discharge type.

FIG. 18 is a view for illustrating the energy level of xenon.

### DETAILED DESCRIPTION OF THE INVENTION

The inventors of the present invention conducted indepth study to search for a possibility of a new type of light-emitting device that can solve the problems of conventional opposing discharge type and surface discharge type of light-emitting devices. As a result, they attained such a new type of light-emitting device. That is to say, they can realize a new type of light-emitting device that has overcome the problems in the conventional opposing type device that the distance between the electrodes cannot be increased, the electrodes are formed on the surface from which light emits, and phosphors deteriorate significantly, and has overcomes the problems in the conventional surface discharge type device that the discharge plasma is easily affected by the surface of the substrate

The light-emitting device according to the present invention includes a plurality of electrodes provided in the discharge space inside a discharge container, each of which is covered with a dielectric structure in its circumference. More specifically, unlike any of the conventional types of light-emitting devices, the electrodes are provided in the discharge space, and the circumference of each of the plurality of electrodes is covered with a dielectric structure. Since the electrodes are provided in the discharge space, there is no need of forming the electrodes on a surface from which light emits, and the distance between the electrodes can be arbitrarily set without depending on the size of the substrates or the distance between the substrates. Furthermore, the influence of the surface of the substrate on the discharge plasma can be reduced. In addition, discharge occurs between the electrodes provided in the discharge space, and therefore the problem of deterioration of phosphors can be avoided. The circumference of the electrode is covered with a dielectric structure, so that dielectric barrier discharge that can provide high light emission efficiency can be performed, and the electrodes cannot be exposed to the discharge space.

When the dielectric structure is spaced away from the discharge container except at a portion where the dielectric structure is supported by the discharge container, it is possible to reduce the influence of the discharge container (substrates) more effectively. As the dielectric structure, a glass tube can be used, and an electrode (e.g., linear electrode made of Al) can be provided inside the glass tube. When the electrode is hollow inside or has a mesh structure, damages or cracks generated by the difference in the coefficient of thermal expansion between the electrode and the dielectric structure (e.g., glass tube) can be prevented effectively.

In the case of a light-emitting device using a rare gas, at least a rare gas is enclosed in the discharge space as a luminous substance. When the discharge container is provided with a translucent portion in at least one portion, and a light-emitting layer is provided in at least one portion on the inner surface of the discharge container, ultraviolet light caused by the rare gas can be let out as visible light. If mercury is not enclosed in the discharge container, a light-emitting device that is preferable in view of global environment protection can be provided.

Hereinafter, embodiments of the present invention will be described with reference to the accompanying drawings. The present invention is not limited to the following embodiments.

Embodiment 1

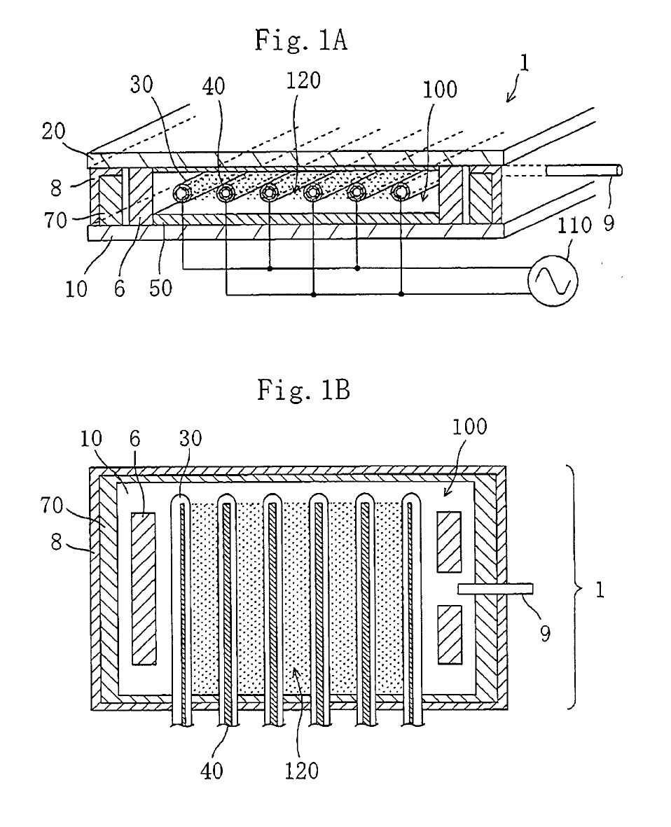

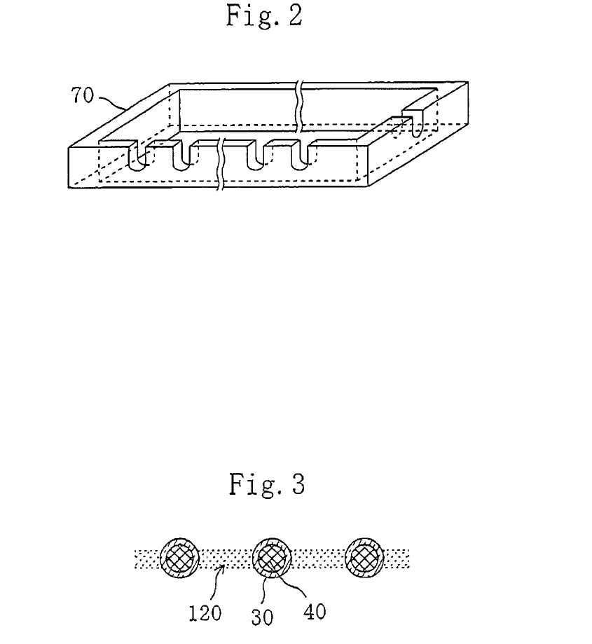

A light-emitting device of Embodiment 1 of the present invention will be described with reference to FIGS. 1A and 1B and FIG. 2 FIG. 1A is a schematic vertical cross-sectional view of the light-emitting device of Embodiment 1 FIG. 1B is a schematic horizontal cross-sectional view of the light-emitting device of Embodiment 1. FIG. 2 is a schematic view showing a configuration of a frame included in the light-emitting device of this embodiment.

The light-emitting device shown in FIGS. 1A and 1B includes a discharge container 1 having a discharge space 100 therein and a plurality of electrodes 40 provided in the discharge space 100, each of which is covered with a dielectric structure 30 in its circumference. An alternating voltage is to be applied to the plurality of electrodes 40. In this embodiment, the discharge container 1 includes a front substrate 20 and a back substrate 10 that are opposed to each other. The space sandwiched by the front substrate 20 and the back substrate 10 constitutes the discharge space 100. The thickness of the front substrate 20 and the back substrate 10 is, for example, 2.8 mm and 2.8 mm, respectively. The distance between these substrates is 4.8 mm. In the discharge space 100, a rare gas (e.g., xenon) is enclosed as a light-emitting material and a discharge plasma 120 of the rare gas is generated between the electrodes 40 during operation of the light-emitting device. In this embodiment, xenon with 13.3 kPa is enclosed as the light-emitting material.

The front substrate 20 and the back substrate 10 are both made of translucent soda-lime glass. A light-emitting layer 50 made of phosphors is formed on each of the front substrate 20 and the back substrate 10 (the inner surface of the discharge container 1). Since the inner surface of the discharge container 1 is provided with the light-emitting layers 50, ultraviolet light emitted from discharge plasma 120 can be converted into visible light so that the light is let out. For example, phosphors for plasma display panels can be used as the phosphors constituting the light-emitting layer 50.

Spacers 6 for defining the distance between the substrates are provided between the front substrate 20 and the back substrate 10, and a rectangular frame 70 is provided in the periphery of the back substrate 10 that is located outside of the spacers 6. As shown in FIG. 2, the frame 70 is provided with a plurality of slots (U-shaped slots in FIG. 2) for passing the dielectric structures 30 through. Using these slots, the dielectric structure 30 including the electrode 40 therein can be received and supported. In this embodiment, all the slots for the dielectric structures 30 are provided equidistantly with the same height and the same size. An exhaust pipe 9 for introducing a luminous material such as a rare gas into the discharge space 100 is provided on a side of the discharge container 1, and a slot for passing the exhaust pipe 9 through as well as the slots for passing the dielectric structures 30 through is formed on the frame 70. The frame 70, the front substrate 20 and the back substrate 10 are sealed with a low melting point glass 8, and thus the discharge space 100 is sealed. Instead of the slots, openings (through holes) can be provided in the frame 70.

Each of the plurality of electrodes 40 provided in the discharge space 100 is provided inside the dielectric structure 30 so as not to be exposed to the discharge space 100, and is extended to the outside of the discharge container 1. Each of the plurality of electrodes 40 of this embodiment is hollow inside. The hollow electrode structure can be achieved by rolling aluminum foil into a cylinder the hollow electrode structure can prevent cracks (damages) in the dielectric structure 30 that may be caused by the difference in the coefficients of thermal expansion between the electrode 40 and the dielectric structure 30 during operation of the light-emitting device.

If cracks occur in the dielectric structures 30, the rare gas enclosed therein leaks out and thus the discharge container 1 cannot be operated. Generally, the coefficient of thermal expansion of the electrode 40 is higher than that of the dielectric structure 30. Therefore, when the temperature at the electrodes 40 increases during operation, a large stress is applied to the dielectric structures 30, which may cause a crack. If the insides of the electrodes 40 are hollow, the stress to the dielectric structures 30 can be minimized and the durability of the discharge container 1 can be improved. Furthermore, as shown in FIG. 3, when the electrodes 40 have a mesh structure, the same effect can be obtained. Even if the insides of the electrodes 40 or the spaces between the meshes are filled with an insulating material having a lower coefficient of thermal expansion than that of metals, the same effect can be obtained.

In this embodiment, each dielectric structure 30 is supported at one portion (one end) so as to make it difficult to apply a stress to the dielectric structure 30 during production of a light-emitting device. More specifically, when it is supported at both ends, the following problem is caused. The dielectric structures 30 are adhered to the discharge container 1 while the dielectric structures 30 are expanded by heat in the process of production of a light-emitting device. Therefore, when the temperature of the dielectric structures 30 is returned to room temperature, the tensile stresses are applied to the dielectric structures 30 from both sides thereof. Thus, each of the dielectric structures 30 is supported at one end in order to prevent such a stress from being applied thereto. However, each dielectric structure 30 can be supported at two portions (both ends), when the dielectric structures 30 are constructed in such a manner that little stress is applied thereto by, for example, selecting an appropriate material constituting the dielectric structure 30.

The plurality of electrodes 40 in the discharge space 100 is disposed equidistantly on a plane that is parallel to the front substrate 20 or the back substrate 10. Such an arrangement allows the electric field intensity between the electrodes 40 to be constant, and allows the electron density distribution between the electrodes to be constant by fixing the distance between the electrodes 40 and the front substrate 20 or the back substrate 10 to be constant. As a result, a more uniform light-emitting surface can be obtained. Furthermore, by arranging the plurality of electrodes 40 on a plane, a thin light-emitting device can be obtained and used preferably as a backlight for flat displays such as liquid crystal displays (liquid crystal panels). When the electrodes 40 are disposed on a plane, the shadows of the electrodes 40 are more likely to occur, compared with the case where the plurality of electrodes 40 are, for example, staggered. In practice, however, light that is less affected by the shadows of the electrodes 40 because of scattering by the light-emitting layer 50 can be let out from the discharge container 1.

The dielectric structure 30 covering the circumference of the electrode 40 has an elongated shape and is a tube made of dielectric, for example. In this embodiment, a glass tube (e.g., an outer diameter of 2.8 mm and an inner diameter of 1.6 mm) made of soda-lime glass is used as the dielectric structure 30. A portion (for example, a portion in which the outer circumference of the glass tube is exposed to the discharge space 100) other than a portion supported by the discharge container 1 (for example, a groove of the frame 70) of the glass tube (dielectric structure) 30 is provided in the discharge space 100, spaced away from the discharge container 1. The length of the portion in which the outer circumference of the glass tube is exposed to the discharge space 100 is, for example, about 50 mm As in the case of the electrodes 40, the glass tubes 30 are disposed equidistantly on a plane that is parallel to the front substrate 20 and the back substrate 10. In this embodiment, the distance between the glass tubes 30 is 10 mm. The distance between the glass tube 30 and the front substrate 20 is, for example, 1 mm, and the distance between the glass tube 30 and the back substrate 10 is, for example, 1 mm. In this embodiment, the outer surface of the electrode that is hollow inside (cylindrical aluminum electrode) 40 is tightly attached to the inner surface of the glass tube 30 without any gap to prevent unwanted discharge (e.g., discharge generating ozone) from occurring by the presence of air between the electrode 40 and the glass tube (dielectric structure) 30.

Each of the electrodes 40 is connected to a power source 110 for operation at the portion extended to the outside of the discharge container 1 so that one electrode 40 in one glass tube 30 is in the same electrical potential (e.g., either a high voltage potential or the ground potential). As shown in FIG. 1A, in this embodiment, the electrodes 40 are electrically connected to the power source 110 such that electrodes connected to the high voltage side alternate with electrodes connected to the ground side of the power source 110 for operation in order to generate the discharge plasma 120 throughout the substrate to obtain uniform light-emitting surface. To each of the electrodes 40, for example, an alternating pulse of a frequency of 30 kHz, a pulse width of 10 μsec and 2000 Vo-p is applied from the power source 110 for operation.

In this embodiment, as shown in FIG. 1, the area of each of the electrodes positioned at both ends of the plurality of electrodes 40 is a half of the area of each of the electrodes other than those in both ends (electrode positioned in a central portion). In other words, in the configuration of this embodiment, since the outer surfaces of the electrodes 40 are tightly attached to the inner surfaces of the glass tubes 30, the contact area of the electrodes 40 provided in the glass tubes 30 positioned in both ends with the glass tubes 30 is a half of the contact area of the other electrodes 40 with the glass tubes 30. Such a configuration allows discharge to occur between every pair of adjacent electrodes of the plurality of electrodes 40 and provides a more uniform light-emitting surface. The inventors of the present invention confirmed by experiments that when the area of the electrodes at both ends is a half, discharge occurs between every pair of adjacent electrodes. This will be described in detail below.

First, the inventors of the present invention confirmed by experiments that in a configuration where all the electrode areas of the plurality of electrodes 40 are the same, discharge easily occurs between a pair of electrodes. More specifically, when all the electrode areas of the plurality of electrodes 40 are the same, in the configuration shown in FIG. 1, discharge easily occurs between the first and the second electrodes from the left, between the third and the fourth electrodes, and between the fifth and the sixth electrodes, whereas no discharge occur or only a weak discharge occurs between the second and the third electrodes from the left, and between the fourth and the fifth electrodes.

On the other hand, in a configuration where the electrode area at both ends is half, it was confirmed by experiments that discharge occurs satisfactorily between every pair of adjacent electrodes, that is, between every pair of adjacent electrodes of the first to sixth electrodes from the left in FIG. 1. It is inferred that this is because when the electrode area at both ends is a half, every electrode can perform discharge in an electrode area (S/2), which is a half of the area (S) of the central electrodes, with respect to the adjacent electrodes. On the other hand, it is inferred that when all the electrode areas of the electrode 40 are the same, more stable discharge can be obtained when discharge is performed in the electrode area S between a pair of electrodes than when discharge is performed between every pair of adjacent electrodes.

Next, the operation of the light-emitting device of this embodiment will be described.

First, an alternating voltage (e.g., alternating pulse voltage) is applied to the plurality of electrodes 40 electrically connected to either the high voltage side or the ground side of the power source 110 for operation. Then, the dielectric constituting the glass tubes 30 is polarized, and an electric field occurs between the plurality of electrodes 40. When this electric field exceeds the discharge start electric field of the enclosed xenon gas, microdischarges start. At this time, charges are accumulated on the surface of the dielectric by the microdischarges. When the synthesized electric field of the internal electric filed caused by these accumulated charges and the external electric field in the opposite direction caused by the polarization of the dielectric becomes lower than the discharge maintaining electric field, the microdischarges end.

Since the microdischarges last for very short time, immediately after the end of the microdischarges, the next microdischarges start in a location where microdischarges have not occurred yet. This microdischarge is repeated, so that the discharge plasma 120 is spread uniformly between the plurality of electrodes 40. The inventor of the present invention confirmed that the discharge plasma 120 is spread uniformly. When occurrence of the microdischarges all over stops, the discharge ends completely.

Next, a voltage in the opposite direction is applied to the plurality of electrodes 40. When the sum of the electric field caused by the charges accumulated on the surface of the dielectric 30 and the electric field occurring between the electrodes 40 by the voltage applied to the electrodes exceeds the discharge start voltage, discharge starts again. In this manner, every time the direction in which the voltage is applied to the electrodes is changed, the start and stop of discharge is repeated.

Ultraviolet light emitted by the discharge plasma 120 is converted to visible light by the light-emitting layers 50 on the back substrate 10 and the front substrate 20, and this visible light is guided outside the discharge container 1. With such an operation, the light-emitting device of this embodiment shows the intensity of 10,000 (cd/m²) or more, and thus a uniform white light-emitting surface having a very high intensity and a very high efficiency can be achieved.

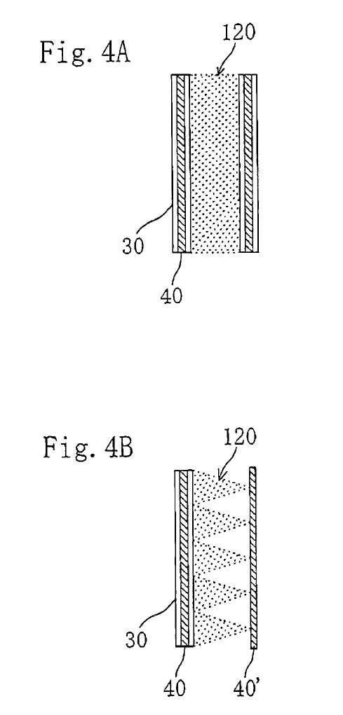

In this embodiment, the light-emitting device is operated by applying an alternating voltage to the electrodes 40 for the following reason. The reason will be described with reference to FIGS. 4A and 4B.

As shown in FIG. 4A, when an alternating voltage is applied to the electrodes 40, uniform discharge plasma 120 can occur between the electrodes 40. In addition, in the light-emitting device of this embodiment, all the electrodes 40 are covered with the dielectric structures (glass tubes) 30, and therefore all the electrodes 40 can be protected from ions during discharge, so that a longer life of the electrodes 40 can be achieved.

On the other hand, as shown in FIG. 4B, when the light-emitting device is operated with direct current (DC) instead of the alternating voltage, the following problems are caused. When the device is operated with direct current (for example, in the case of operation with a monopolar pulse), a discharge pillar (discharge plasma) 120 is spread in a fan shape from a negative pole 40′ to a positive pole 40, so that the discharge pillar near the negative pole 40′ is sparse. As a result, the intensity of the light-emitting layer near the negative pole is reduced. In other words, compared with the case of the alternating voltage, nonuniformity in the intensity is increased. When the device is operated with direct current, as in the configuration shown in FIG. 4B, the negative pole can be configured as a bare electrode 40′. However, in such a configuration, ions collide directly with the bare electrode 40′ during discharge, so that the electrode is sputtered. As a result, the life of the electrode can be shortened. Furthermore, roughness on the electrode is caused by sputtering, so that non-uniformity in discharge can be spread. Moreover, there is a problem in that scattered electrode can be attached onto the surface of the light-emitting layer. If the device is operated with alternating voltages in the configuration shown in FIG. 1, these problems can be avoided

In the light-emitting device of this embodiment, the plurality of electrodes 40 each of which is covered with the dielectric structure 30 is provided in the discharge space 100. Therefore, unlike the conventional light-emitting devices, there is no need of forming the electrodes on the surface from which light is let out. As a result, a light-emitting surface that is highly luminous and uniform can be obtained. Moreover, since the dielectric structure 30 has an elongated shape, the adverse effect that the dielectric structures 30 may block the light emission from the light-emitting layer 50 on the back substrate 10 can be minimized

Furthermore, since the plurality of electrodes 40 is provided in the discharge space 100, the distance between the electrodes 40 can be increased within the range in which the start voltage does not become too high, without depending on the size of the front substrate 20 or the back substrate 10 or the distance between the substrates. In addition, since the plurality of electrodes 40 is provided in the discharge space 100, the discharge plasma 120 can be spaced away from the front substrate 20 or the back substrate 10, so that an excessive increase of the electron density can be suppressed. As a result, stable discharge having a high light-emission efficiency can be obtained. Moreover, since ions in the discharge plasma 120 do not collide directly with the light-emission layer 50 (phosphor layer), the phosphors in the light-emitting layer 50 hardly deteriorate. As a result, high intensity can be maintained for a long time.

Thus, according to this embodiment, a light-emitting device having more excellent characteristics than those of the conventional light-emitting devices can be provided.

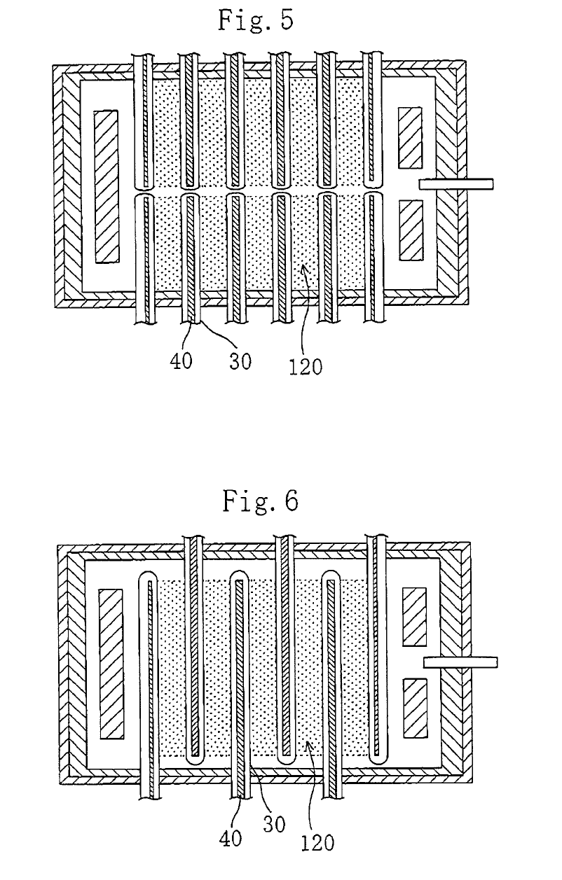

When the light-emitting device of this embodiment is used as a backlight for flat displays with a large screen, as shown in FIG. 5, the dielectric structures (glass tubes) 30 and the electrodes 40 can be extended from both sides of the frame 70 into the discharge space 100. If the glass tubes 30 are extended from both sides of the frame 70 and supported at one end thereof, a stress applied to the glass tube 30 in the supported portion of the frame 70 can be less than when a long glass tube 30 is extended from one side of the frame 70 and supported at one end. That is to say, when, instead of one long glass tube 30, two glass tubes 30 having a length of a half of that long glass tube are used, then a stress applied to the supported portion by the self-weight of the glass tube 30 can be reduced significantly. As a result, the possibility that the glass tube 30 is damaged can be reduced.

Futhermore, a variation of the configuration of FIG. 5 can be used. As shown in FIG. 6, the electrodes 40 on the high voltage side can be extended from one side, and the electrodes 40 on the ground side can be extended from the other side. With this configuration, in addition to the effect provided by the configuration of FIG. 5, wiring between the electrodes 40 and the power source 110 for operation can be simplified. Since lines of different poles are spaced away, current leaks can be prevented.

In the configurations shown in FIGS. 1, 5 and 6, a stand (not shown) for supporting the head of the glass tube 30 can be provided, for example, under the head of the glass tube 30 positioned in the discharge space 100, and the head of the glass tube 30 can be supported by that stand to reduce a stress applied to the supported portion of the glass tube 30. If the head of the glass tube 30 and the stand are not fixed, even if thermal contraction occurs in the glass tube 30 during production process, a tensile stress cannot be applied to the glass tube 30, so that damages to the glass tube 30 can be prevented.

Next, a method for producing a light-emitting device of this embodiment will be described.

First, a back substrate 10 (a thickness of 2.8 mm) and a front substrate 20 (a thickness of 2.8 mm) that are made of translucent soda-lime glass are prepared, and then a light-emitting layer 50 is formed on the back substrate 10 and the front substrate 20. The light-emitting layer 50 can be formed in the following manner.

First, phosphors for plasma display panels of three colors of RGB are sufficiently dispersed in a vehicle (e.g., α-terepineol+25 wt % of acrylic resin) as a dispersion medium. As the phosphors for plasma display panels of three colors of RGB, for example, an europium activated yttrium gadolinium oxide borate phosphor having a central wavelength of emission in the vicinity of 590 nm, 610 nm, and 630 nm, a magnesium activated aluminic acid phosphor having a central wavelength of emission in the vicinity of 515 nm, and an europium activated barium magnesium aluminate phosphor having a central wavelength of emission in the vicinity of 455 nm can be used. Next, the phosphors dispersed in the vehicle are printed on substrates by screen printing and uniform layers of the phosphors are formed. Then, the layers are dried sufficiently, and then the vehicle is fired and scattered by heating and firing at an ambient temperature of 450° C. so that the light-emitting layers 50 adhered to the surfaces of the back substrate 10 and the front substrate 20 can be obtained.

Next, in order to determine the distance between the substrates, for example, as shown in FIG. 1B, spacers 6 having a thickness of 4.8 mm and made of soda-lime glass are disposed in the periphery of the back substrate 10, and a rectangular frame 70 (a length of the long side of 90 mm, a length of the short side of 64 mm, and a height of 3.8 mm) is provided further outside. The frame 70 is made of soda-lime glass and, as shown in FIG. 2, the frame 70 is provided with a plurality of U-shaped grooves for passing dielectric structures (glass tubes) 30 and an exhaust pipe 9 through. The plurality of grooves for the dielectric structures 30 are provided equidistantly with the same height and the same size.

Next, the plurality of tubular dielectric structures (glass tubes) 30 having an outer diameter of 2.8 mm and an inner diameter of 1.6 mm and made of, for example, soda-lime glass, and an exhaust pipe 9 also made of soda-lime glass are disposed in the predetermined grooves of the frame 70. The distances between the adjacent dielectric structures 30 is, for example, 10 mm, and the length of a portion of the glass tube 30 that is positioned in the discharge container 1 is, for example, 50 mm.

Next, a low melting point glass paste is prepared from a low melting point glass 8, which is a sealing material (e.g., manufactured by Asahi glass Co.) and a resin dispersion medium (e.g., Vehicle C manufactured by Tokyo Ohka Kogyo Co. Ltd.). Then, the low melting point glass paste is discharged uniformly on the upper portion of the frame 70 by, for example, a dispenser, and further discharged to fill the grooves of the frame 70 in which the dielectric structures 30 and the exhaust pipe 9 are disposed. Next, discharge and drying are repeated until the total height of the thickness of the low melting point glass paste and the height of the back substrate 10 becomes several mm higher than the height of the spacers 6. Thereafter, the low melting point glass paste is discharged and dried along the portion outside the portion in which the frame 70 and the back substrate 10 are in contact. Next, the back substrate 10 provided with the frame 70 and the front substrate 20 on which the light-emitting layer 50 is formed are attached and fixed with heat resistant metal fixtures. Then, this is fired by heating at an ambient temperature of 450° C. so that lead glass powder in the low melting point glass paste is molten and the resin dispersion medium is fired and scattered. Thus, the back substrate 10 and the front substrate 20 are hermetically attached with the low melting point glass 8 with a gap of the thickness of the spacer 6. With these processes as above, the back substrate 10, the front substrate 20 and the frame 70 are adhered to form into one unit, and thus the discharge container 1 can be obtained.

Next, the exhaust pipe 9 is connected to a vacuum pump (not shown) and impurity gas in the discharge container 1 is exhausted at an atmosphere with 350° C. Then, after the atmosphere is returned to room temperature, a rare gas, for example, of a single gas of xenon is enclosed to 13.3 kPa.

Thereafter, the exhaust pipe 9 is sealed with a burner or the like, and unwanted portions are removed.

Next, electrodes 40 made of, for example, aluminum foil are formed into cylinders, and the cylindrical electrodes are attached onto the inner surfaces of the dielectric structures 30 without any gap between them. At this time, on the inner surfaces of the dielectric structures 30 positioned at both ends of the plurality of the dielectric structures 30, the electrodes 40 are attached to a half of the surface that is on the side on which the neighboring dielectric structures 30 are disposed. Thus, the light-emitting device of this embodiment can be obtained.

The electrodes 40 of the obtained light-emitting device are connected to the high voltage side and the ground side of the power source 110 for operation alternately. When an alternating pulse of, for example, a frequency of 30 kHz, a pulse width of 10 μsec, and 2000 Vo-p is applied from the power source 110 for operation to each of the electrodes 40, the light-emitting device can be operated.

The method of this embodiment requires only the total of three high temperature processes of forming the light-emitting layers, sealing and evacuation, at a temperature of at 450° C. at the maximum. Therefore, compared with the prior art, the production process can be simplified significantly, and in addition, it is not necessary to use a thick glass substrate. Furthermore, thermal strain on the back substrate 10 and the front substrate 20 can be suppressed. In the production process of this embodiment, the electrodes 40 can be provided after a rare gas is enclosed to the discharge container 1, that is, after the thermal process is completed, so that the electrodes 40 are not oxidized by heat, and thus can have a low resistivity.

Embodiment 2

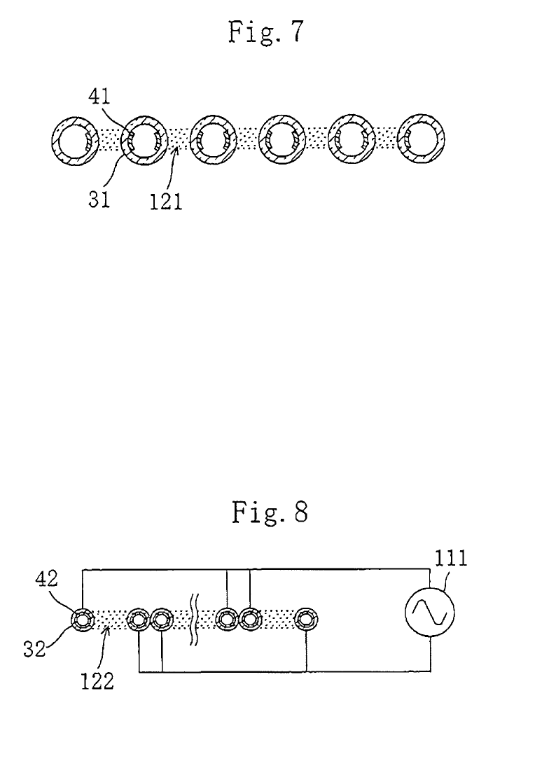

A light-emitting device of Embodiment 2 according to the present invention will be described with reference to FIG. 7. FIG. 7 is a schematic view of the cross-sectional configuration (the cross-sectional configuration in a direction perpendicular to the back substrate 10) of a plurality of electrodes 41 of the light-emitting device of this embodiment.

The light-emitting device of this embodiment is different from that of Embodiment 1 in that the electrodes 41 are split into at least two portions in the longitudinal direction of the dielectric structures (glass tubes) 31. In the configuration shown in FIG. 7, the dielectric structures 31 have the same structure as that of the dielectric structures 30 of Embodiment 1, and a discharge plasma 121 occurs in the same mechanism as that of the discharge plasma 120 of Embodiment 1. For simplification of description, in this embodiment and the following embodiments, the different aspects from Embodiment 1 will be mainly described, and the same aspects as in Embodiment 1 will be omitted or simplified.

As shown in FIG. 7, the electrodes 41 of this embodiment are split into at least two portions along the longitudinal direction of the dielectric structures (glass tubes) 31. The electrodes 41 shown in FIG. 7 lacks the upper portion and the lower portion of the electrodes 40 of Embodiment 1 and have two portions extending along the axis direction of the glass tubes 31 (left portion and right portion). The two portions are opposed to the two portions of the electrode 41 in the adjacent glass tube 31 That is to say, the two portions of each of the plurality of electrodes 41 are disposed in a direction parallel to the back substrate 10 (or the front substrate 20). The distance between the left portion and the right portion (the gap of the upper portion and the lower portion) in the electrodes 41 is, for example, about 1.5 mm. As in the electrodes 40 of Embodiment 1, the outer surface of the left portion and the right portion are attached tightly to the inner surfaces of the glass tube 31.

The light-emitting device of this embodiment has the electrodes 41 having the structure shown in FIG. 7. Therefore, uniform discharge plasma 121 can be generated from both sides of the dielectric structure 31, and visible light is not prevented from proceeding in the direction perpendicular to the substrate by the electrodes 41. Therefore, the shadows of the electrodes 41 on the light-emitting surface can be suppressed. Thus, a light-emitting surface having a very high uniformity can be obtained.

In addition to the above effect, the same effect as in Embodiment 1 can be obtained.

Embodiment 3

A light-emitting device of Embodiment 3 according to the present invention will be described with reference to FIG. 8. FIG. 8 is a schematic view of the cross-sectional configuration (the cross-sectional configuration in a direction perpendicular to the back substrate 10) of a plurality of dielectric structures 32 of the light-emitting device of this embodiment Only the dielectric structures 32 in the vicinity of both ends are shown and the other dielectric structures are omitted.

The light-emitting device of this embodiment is different from that of Embodiment 1 in that the dielectric structures 32 positioned in a central portion other than both ends are in contact with adjacent dielectric structures. In the configuration shown in FIG. 8, the dielectric structures 32 and the electrodes 42 have the same structures as those of the dielectric structures 30 and the electrodes 40 of Embodiment 1, and discharge plasma 122 occurs in the same mechanism as that of the discharge plasma 120 of Embodiment 1.

As shown in FIG. 8, in the light-emitting device of this embodiment, the dielectric structures 32 positioned in the central portion other than both ends are in contact with adjacent dielectric structures in a direction parallel to the substrate In other words, each of the electrodes 42 positioned at both ends is provided in one dielectric structure 32, and the electrodes 42 positioned in the central portion are provided in the dielectric structures 32 in such a manner that two dielectric structures 32 are in contact with each other and one electrode 42 is provided in each of the two dielectric structures 32. The two electrodes makes one pair in the central portion, so that the sum of the electrode area of the electrodes 42 (two electrodes) positioned in the central portion is twice the electrode area of each of the electrodes 42 positioned at both ends. The two dielectric structures 32 are not necessarily attached tightly, but can be slightly in contact with each other. Alternatively, a small gap is allowable.

The electrodes 42 are electrically connected to the power source 111 for operation such that the electrodes making a pair in the central portions can have the same potential. In addition, the electrodes 42 are electrically connected to the power source 111 for operation such that opposite potentials are applied to the adjacent electrodes 42 or the adjacent pair of two electrodes 42 that are spaced away. That is to say, the electrodes connected to the high voltage side of the power source and the electrodes connected to the ground side are disposed alternately. The area in which the inner surface of the dielectric structure 32 is in contact with the electrode 42 is equal among all the dielectric structures 32.

In the light-emitting device of this embodiment, the dielectric structures 32 positioned in the central portion other than both ends are in contact with the adjacent one, so that the sum of the electrode area of the electrodes 42 (two electrodes of a pair) positioned in the central portion is twice the electrode area of each of the electrodes 42 positioned at both ends. Therefore, with a configuration using dielectric structures 32 in which the contact area of the inner surface of the dielectric structure 32 and the electrode 42 is the same among all the dielectric structures 32, discharge plasma 122 can be generated between every pair of the adjacent electrodes, as in Embodiment 1. As a result, a more uniform light-emitting surface can be obtained as in Embodiment 1.

In the light-emitting device of this embodiment, the dielectric structures 32 having the same structure and the electrodes 42 having the same structure can be used Therefore, a light-emitting device that allows the discharge plasma 122 to be generated between every pair of adjacent electrodes can be produced more easily that the light-emitting device of Embodiment 1. In this embodiment, two dielectric structures 32 are attached in a direction parallel to the substrates. However, also in a configuration in which two dielectric structures 32 are attached in a different direction, for example, a direction perpendicular to the substrates, the sum of the electrode area of a pair of electrodes 42 in the central portion can be twice the electrode area of each of the electrodes 42 positioned at both ends, so that the same effect can be obtained.

In addition to the above effect, the same effect as in Embodiment 1 can be obtained.

Embodiment 4

Next, a light-emitting device of Embodiment 4 according to the present invention will be described. The light-emitting device of this embodiment is different from that of Embodiment 1 in that at least part of the outer surface of the dielectric structure 30 of the light-emitting device of Embodiment 1 is coated with a material that reflects visible light (e.g., magnesium oxide). The other aspects are the same as Embodiment 1, so that description thereof will be omitted.

The surface of the dielectric structure is coated with magnesium oxide in the following manner, for example. First, butyl acetate as a dispersion medium and ethyl cellulose as a binder are added to particulate magnesium oxide. Then, the mixture is stirred sufficiently, and then the mixture is applied onto the surface of the dielectric structure. Next, the applied mixture is dried sufficiently, and then fired at 450 to 550° C. to fire and scatter the dispersion medium and the binder. Thus, magnesium oxide adhered onto the surface of the dielectric structure can be obtained.

In this embodiment, at least part of the outer surface of the dielectric structure of the light-emitting device of Embodiment 1 is coated with a material that reflects visible light (e.g., magnesium oxide). Therefore, visible light emitted from the light-emitting layer 50 is hardly absorbed by the dielectric structures and guided to the outside of the substrate. As a result, even higher intensity can be achieved.

In addition to the above effect, the same effect as in Embodiment 1 can be obtained.

Embodiment 5

Next, a light-emitting device of Embodiment 5 according to the present invention will be described. The light-emitting device of this embodiment is different from that of Embodiment 1 in that at least part of the outer surface of the dielectric structure 30 of the light-emitting device of Embodiment 1 is coated with a material that reflects ultraviolet light (e.g., aluminum oxide). Other aspects are the same as Embodiment 1, so that description thereof will be omitted.

The surface of the dielectric structure is coated with aluminum oxide, for example, by using particulate aluminum oxide instead of the particulate magnesium oxide used in Embodiment 4.

In this embodiment, at least part of the outer surface of the dielectric structure is coated with a material that reflects ultraviolet light. Therefore, ultraviolet light generated by discharge of the enclosed gas is hardly absorbed by the dielectric structures and reaches the light-emitting layer to be converted into visible light. As a result, even higher intensity can be achieved. In addition to the above effect, the same effect as in Embodiment 1 can be obtained.

Furthermore, it is possible to combine a visible light reflecting material and an ultraviolet light reflecting material in Embodiments 4 and 5. The same effect can be obtained, regardless of the portion of the surface of the dielectric structure on which the materials are provided or the order of providing the materials. For example, the same effect can be obtained in any of the following cases: in the case where the visible light reflecting material and the ultraviolet light reflecting material are provided in different portions on the surface of the dielectric structure; in the case where the two materials are laminated to be a layer; in the case where powder of each material is mixed to form a layer, or the like,

Embodiment 6

Next, a light-emitting device of Embodiment 6 according to the present invention will be described. The light-emitting device of this embodiment is different from that of Embodiment 1 in that the electrodes 40 of the light-emitting device of Embodiment 1 are translucent. The other aspects are the same as Embodiment 1, so that description thereof will be omitted.

The configuration of this embodiment prevents the shadows of the electrodes 40 from being cast on the light-emitting surface. As a result, an even more uniform light-emitting surface can be obtained. When the dielectric structure 30 is made of, for example, soda-lime glass and the translucent electrodes of this embodiment are used, then a very high visible light transmittance can be achieved. In addition to this effect, the same effect as in Embodiment 1 can be obtained. As a material for the translucent electrodes, for example, indium tin oxide (ITO) can be used in view of low resistance and high visible light transmittance.

A method for forming the electrodes made of indium tin oxide on the inner surface of the dielectric structures will be described below. This process is difficult to perform after sealing of the substrates, and therefore is performed before sealing of the substrates. First, an indium tin oxide solution for dip coating (e.g., ITO-05C manufactured by High Purity Chemical Co.) is prepared and the dielectric structures are immersed into the solution. Then, the dielectric structures immersed into the solution are lifted at a constant speed such that the axis of the electrodes (the longitudinal direction of the electrodes) is oriented to the vertical direction. Thereafter, the solution attached on the outer surface of the dielectric structure is wiped out sufficiently. Finally, the dielectric structures are dried sufficiently, and fired at about 550° C. Thus, the dielectric structure in which indium tin oxide films are formed on their inner surfaces can be attained.

Embodiment 7

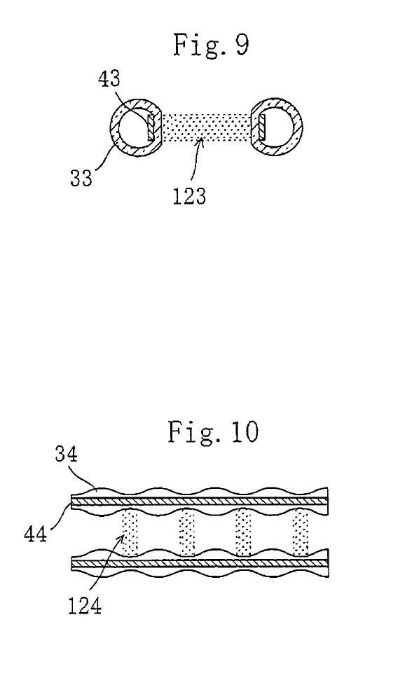

A light-emitting device of Embodiment 7 according to the present invention will be described with reference to FIG. 9. FIG. 9 is a schematic view of the cross-sectional configuration (the cross-sectional configuration in a direction perpendicular to the back substrate 10) of a plurality of dielectric structures 33 of the light-emitting device of this embodiment.

The light-emitting device of this embodiment is different from that of Embodiment 1 in that the dielectric structure 30 of the light-emitting device of Embodiment 1 is provided with at least one flat portion. The other aspects are the same as Embodiment 1, so that description thereof will be omitted.

The light-emitting device of this embodiment has the dielectric structure 33 provided with at least one flat portion, so that further stable and highly efficient discharge can be obtained. That is to say, with this configuration, the electric field distribution in the thickness direction of the discharge container becomes uniform, so that optimal energy for the enclosed gas can be injected. As a result, stable and highly efficient discharge can be obtained. This flat portion is not necessarily extended all over the dielectric structure, but a flat portion can be provided in a portion thereof.

In addition to the above effect, the same effect as in Embodiment 1 can be obtained.

Embodiment 8

A light-emitting device of Embodiment 8 according to the present invention will be described with reference to FIGS. 10 to 14. Each of FIGS. 10 to 14 schematically shows the configuration (the cross-sectional configuration in a direction parallel to the back substrate 10) of the dielectric structures and the electrodes.

The light-emitting device having a configuration shown in FIG. 10 is different from that of Embodiment 1 in that concavities and convexities are provided regularly on the outer surface of the dielectric structure 34. By providing concavities and convexities regularly on the outer surface of the dielectric structure 34, stable and uniform discharge can be obtained even under the conditions in which uniform discharge hardly occurs. For example, in the case where a rare gas such as xenon in which discharge is hardly diffused is enclosed alone at a high pressure, uniform discharge hardly occurs.

Under the conditions in which discharge hardly occurs, when focusing on a pair of dielectric structures, discharge occurring during voltage application is not spread uniformly, but is contracted in a shape of one line. In this state, light does not emit uniformly from the light-emitting surface, but emits in a striped shape. Moreover, an abrupt increase of the electron density leads to an increase of the possibility that the dielectric structures are damaged.

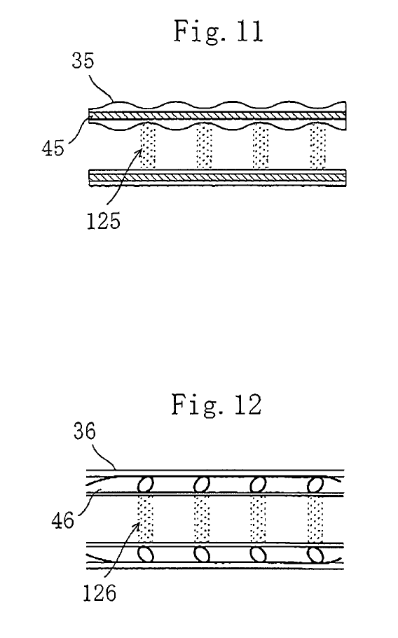

In order to avoid such a problem, as shown in FIG. 10, the distribution of the thickness of the dielectric structure is provided regularly in the axis direction (longitudinal direction). With the configuration shown in FIG. 10, the non-uniformity of the intensity of the electric field can be distributed regularly in the axis direction, and discharge occurs in a portion having a small thickness and a high electric field intensity. As a result, discharge occurs regularly in the axis direction. In the example shown in FIG. 10, the dielectric structure 34 having a varied thickness is used for both dielectric structures of a pair, so that the thickness is varied on both sides of discharge. On the other hand, as in the example shown in FIG. 11, when a varied thickness can be used only on one side of discharge, the same effect also can be obtained.

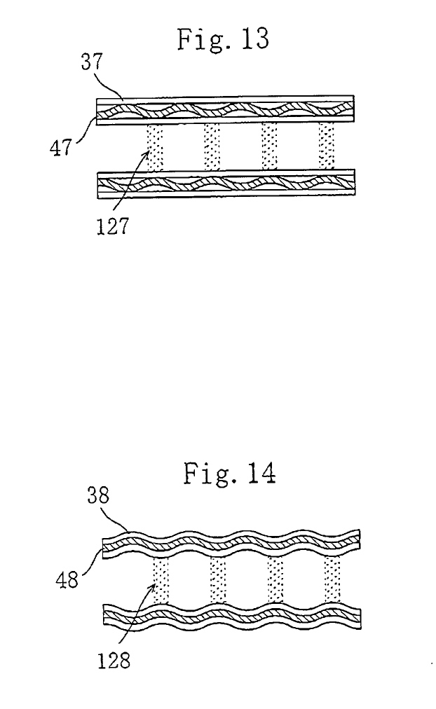

Furthermore, stable and uniform discharge as above can be obtained in the following configurations without providing regular concavities and convexities on the outer surface of the dielectric electrode 36: a configuration where a spiral electrode 46 is provided, as shown in FIG. 12; and a configuration where the electrode 47 is regularly winding, as shown in FIG. 13. Discharge can occur in a portion having a short distance between the electrodes and high electric field intensity by providing a regular distribution of the distance between the electrodes in the axis direction. As a result, discharge can occur regularly in the axis direction. Also in the case where spiral or regularly winding electrodes are used, they can be used on both sides of discharge or only one side of discharge. In both cases, the effect can be obtained.

As shown in FIG. 14, the same effect can be obtained also when the shape of the dielectric structure is changed in accordance with the shape of the electrode 48. In the configuration shown in FIG. 14, the dielectric structure 38 is winding, corresponding to the winding electrode 48.

In addition to the above effect, the same effect as in Embodiment 1 can be obtained.

Embodiment 9

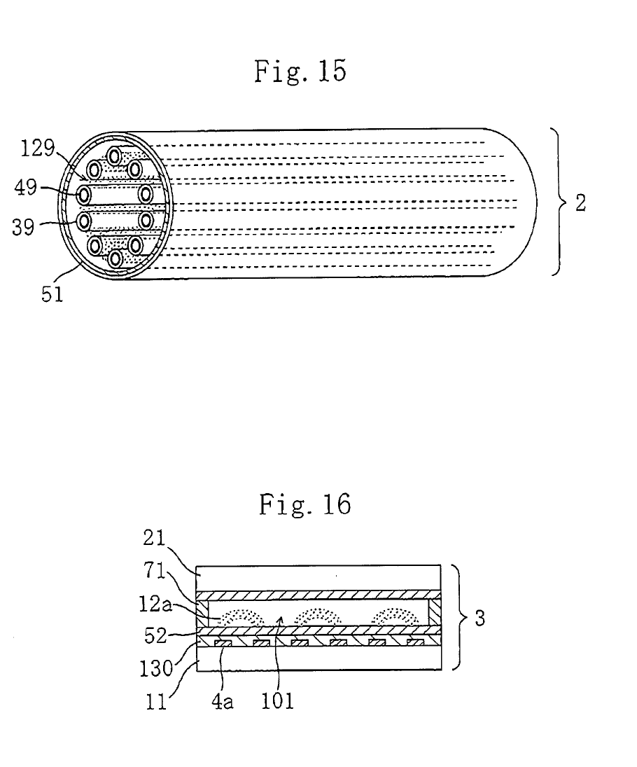

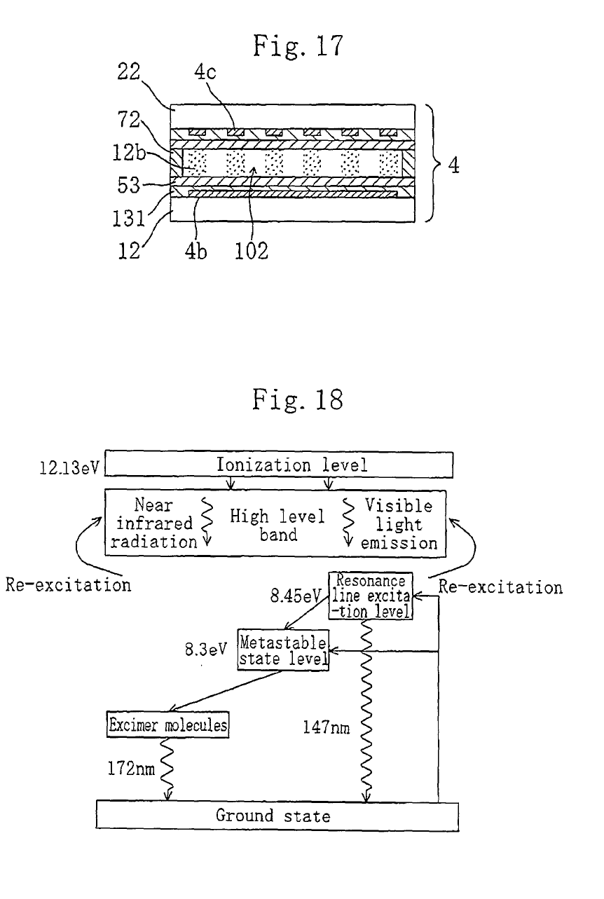

A light-emitting device of Embodiment 9 according to the present invention will be described with reference to FIG. 15. FIG. 15 schematically shows the configuration (the cross-sectional configuration of a discharge container 2 in a radial direction) of the light-emitting device of this embodiment.

The light-emitting device of this embodiment is different from the light-emitting device of Embodiment 1 in that the discharge container is not of a plane shape, but a cylindrical shape. The cylindrical discharge container 2 is made of a translucent material (e.g., soda-lime glass), and a light-emitting layer 51 made of, for example, phosphors is provided on the inner surface of the discharge container 2, as in Embodiment 1. Inside the discharge container 2, a plurality of tubular dielectric structures 39 made of, for example, soda-lime glass are disposed equidistantly with a distance from the inner surface of the discharge container 2, and the plurality of tubular dielectric structures 39 are held at both ends of the discharge container 2.

Inside the discharge container 2, a rare gas such as xenon is enclosed, as in Embodiment 1, and when an alternating voltage or a pulse voltage is applied to the electrodes 49 made of, for example, aluminum foil inside the discharge container 2, a visible light can emit on the same principle as in Embodiment 1. With such a configuration, a highly luminous and uniform cylindrical light-emitting device can be obtained. Also in this embodiment, the same effect as in Embodiment 1 can be obtained.

Other embodiments

In Embodiments 1 to 10, the light-emitting devices with the following configuration as the translucent discharge container have been described: a configuration where the back substrate 10 and the front substrate 20 are sealed with the low melting point glass 8 or a configuration where a cylindrical soda-lime glass is used. However, other shapes, for example, spherical glass can be used as well Furthermore, the front substrate and the back substrate are both made of soda-lime glass, but it is not necessary that both of them are translucent, but it is sufficient that one of them is translucent. Moreover, it is sufficient that both the substrates are made of a material that can withstand the atmospheric pressure or have such a structure, so that other materials, such as translucent ceramics or translucent resin can be used as well. For the configuration where a translucent resin is used, it is preferable to use a translucent material having excellent durability (e.g., a material that has excellent heat resistance and is not deteriorated by ultraviolet rays or the like), and in order to provide such characteristics, a functional film can be provided on the translucent resin separately.

The above embodiments have been described by way of examples using phosphors for plasma display panels for the light-emitting layer 50 (or 51), but the present invention is not limited thereto. Also with other luminous materials that have an exciting band in the wavelength range of occurring ultraviolet light when a rare gas enclosed in the discharge container (discharge space 100) is discharged, the same as above can be achieved. Moreover, when a plurality of luminous materials having different emission wavelengths can be combined, the same as above can be achieved.

In the above embodiments, screen printing has been used to form the light-emitting layers 50 on the back substrate 10 and the front substrate 20. However, the present invention is not limited thereto, and other methods, for example, dipping can be used for the same effect as above.

In the above embodiments, the spacers 6 and the frame 70 are used for sealing. However, it is possible not to use the spacers 6 and to use the frame 70 also as a spacer.

In the above embodiments, a single gas of xenon is used at 13.3 kPa as a rare gas to be enclosed. However, other gas pressures or other gas, for example, a rare gas such as krypton or helium, or a mixed gas of two types of rare gas, or a mixed gas containing at least one type of rare gas and at least one type of halogen such as iodine or chlorine can be used for the same effect as above.

The above embodiments have been described by way of examples using aluminum foil as the electrodes 40 to 49. However, the present invention is not limited thereto, and for example, hollow aluminum rod can be used. Moreover, a material constituting the electrodes is not limited to aluminum, but for example, other metals such as copper or iron can be used.

The above embodiments have been described by way of examples in which the plurality of dielectric structures 30 to 39 are disposed equidistantly on the same plane in parallel to each other. However, other arrangements, for example, where the distance between the dielectric structures are different; or the dielectric structures are staggered or crossed to each other, any arrangements or any shapes for the dielectric structures can be used for the same effect as above.

The above embodiments have been described by way of examples using an alternating pulse of 30 kHz as the voltage to be applied. However, other frequencies can be used or one electrode can be grounded for the same effect as above.

The above embodiments have been described by way of examples that do not use a reflecting material outside the discharge containers 1 and 2. However, when the direction in which light emits is predetermined, a reflecting material such as metal can be provided on the outer surface of the discharge container 1 and 2 for the same effect as above.

The above embodiments have been described by way of examples using the light-emitting layers 50 and 51. However, also in the case where the light-emitting layer is not used and the discharge container 1 and 2 are made of an ultraviolet light transmitting material such as magnesium fluoride, a light-emitting that radiates ultraviolet light can be obtained as the present invention.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A light-emitting device comprising:
a discharge container having a discharge space inside; and
a plurality of electrodes provided in the discharge space, a circumference of each of the plurality of electrodes being covered with a dielectric structure, and an alternating voltage being applied to the plurality of electrodes.

2. The light-emitting device according to claim 1, wherein the dielectric structure is spaced away from the discharge container except at a portion where the dielectric structure is supported by the discharge container.

3. The light-emitting device according to claim 1, wherein
the dielectric structure is a glass tube, and
each of the plurality of electrodes is disposed inside the glass tube so as not to be exposed to the discharge space, and is extended to an outside of the discharge container.

4. The light-emitting device according to claim 1, wherein each of the plurality of electrodes is hollow inside.

5. The light-emitting device according to claim 1, wherein each of the plurality of electrodes has a mesh structure.

6. The light-emitting device according to claim 1, wherein each of the plurality of electrodes is split into at least two portions along a longitudinal direction of the dielectric structure.

7. The light-emitting device according to claim 1, wherein
the discharge container includes a translucent portion in at least one portion, and
a light-emitting layer is provided in at least one portion on an inner surface of the discharge container.

8. The light-emitting device according to claim 1, wherein
the discharge container includes a front substrate and a back substrate that are opposed to each other, and
the plurality of electrodes are disposed equidistantly on a plane that is parallel to the front substrate or the back substrate.

9. The light-emitting device according to claim 1, wherein the discharge container is provided with a groove for receiving a part of the dielectric structure to support the dielectric structure.

10. The light-emitting device according to claim 1, wherein the plurality of electrodes is disposed such that electrodes connected to a high pressure side of a power source alternate with electrodes connected to a ground side of the power source.

11. The light-emitting device according to claim 10, comprising pairs of dielectric structures, the dielectric structures of each pair being in contact with each other,
wherein electrodes whose circumferences are covered with a pair of dielectric structures that are in contact with each other are in a same electrical potential, and
the electrodes that are in the same electrical potential constitute the electrodes connected to the high pressure side of the power source or the electrodes connected to the ground side of the power source.

12. The light-emitting device according to claim 1, wherein an area of each electrode positioned at both ends of the plurality of electrodes is a half of an area of each electrode positioned in a portion other than the both ends.

13. The light-emitting device according to claim 12, wherein
the plurality of electrodes are covered with the dielectric structures such that one dielectric structure covers a circumference of one electrode, and
the area of each electrode positioned in a portion other than both ends is substantially equal.

14. The light-emitting device according to claim 12, wherein
each of the electrodes positioned at both ends is an electrode whose circumference is covered with one dielectric structure, and
the electrodes positioned in a portion other than the both ends are electrodes each of which is covered with one dielectric structure in its circumference, the electrodes being constituted with pairs of two adjacent electrodes, and the dielectric structures covering the two adjacent electrodes are in contact with each other, and
a sum of the electrode area of the two electrodes is twice the area of each of the electrodes positioned at the both ends.

15. The light-emitting device according to claim 1, wherein at least one portion on a surface of each electrode of the plurality of electrodes is attached tightly to the dielectric structure.

16. A backlight for a flat display comprising:
a discharge container having a discharge space inside, in which at least a rare gas is enclosed as a luminous material in the discharge space;
a plurality of tubes made of dielectric and provided in the discharge space while being spaced away from the discharge container except at a portion at which the tubes are supported by the discharge container; and
electrodes each of which is provided in each of the plurality of tubes and to which an alternating voltage is applied,
wherein the discharge container includes a front substrate and a back substrate that are opposed to each other, and the plurality of tubes are disposed on a plane that is parallel to the front substrate or the back substrate, and
the discharge container includes a translucent portion in at least one portion, and
a light-emitting layer is provided in at least one portion on an inner surface of the discharge container.
